(19) United States
(12) Patent Application Publication
(10) Pub. No.: US 2022/0297499 A1
(43) Pub. Date: Sep. 22, 2022

(54) MULTI-ZONE HVAC

(71) Applicant: DENSO International America, Inc., Southfield, MI (US)

(72) Inventor: Michael TUCKER, Sterling Heights, MI (US)

(21) Appl. No.: 17/203,653

(22) Filed: Mar. 16, 2021

(51) Int. Cl. B60H 1/00

(52) U.S. Cl. CPC B60H 1/00057; B60H 2001/00121; B60H 2001/00135

(57) ABSTRACT

A refrigerant heat exchanger including a first group of heat exchange tubes on a first side of a core defining a first zone. A second group of heat exchange tubes on a second side of the core define a second zone. An inlet tank is at the inlet end of the core. An inlet port of the inlet tank is opposite to, or generally opposite to, an interface between the first zone and the second zone. A first outlet tank is at the outlet end of the core opposite to the first zone. A first outlet port of the first outlet tank is at an outer end of the first outlet tank. A second outlet tank is at the outlet end of the core opposite to the second zone. A second outlet port of the second outlet tank is at an outer end of the second outlet tank.

### FIELD

The present disclosure relates to a multi-zone heating, ventilation, and air conditioning (HVAC) system, such as for a vehicle.

### BACKGROUND

This section provides background information related to the present disclosure, which is not necessarily prior art.

Many vehicle heating, ventilation, and air conditioning (HVAC) systems have multi-zone functionality, which allows the HVAC system to maintain one zone at a different temperature from another zone. For example, with a front dual zone vehicle HVAC, the driver's side and passenger's side may be maintained at different temperatures. While such multi-zone HVAC systems are suitable for their intended use, they are subject to improvement. The present disclosure advantageously provides for improved multi-zone HVAC systems including the advantages set forth herein.

### SUMMARY

This section provides a general summary of the disclosure, and is not a comprehensive disclosure of its full scope or all of its features.

The present disclosure includes an HVAC system with a refrigerant heat exchanger including a core having a plurality of heat exchange tubes extending from an inlet end of the core to an outlet end of the core. A first group of the plurality of heat exchange tubes on a first side of the core define a first zone. A second group of the plurality of heat exchange tubes is on a second side of the core define a second zone. An inlet tank is at the inlet end of the core. An inlet port of the inlet tank is opposite to, or generally opposite to, an interface between the first zone and the second zone of the core. A first outlet tank is at the outlet end of the core opposite to the first zone. A first outlet port of the first outlet tank is at an outer end of the first outlet tank. A second outlet tank is at the outlet end of the core opposite to the second zone. A second outlet port of the second outlet tank is at an outer end of the second outlet tank.

The present disclosure further provides for a vehicle HVAC system including a refrigerant heat exchanger having a core with a plurality of heat exchange tubes extending from an inlet end of the core to an outlet end of the core. A first group of the plurality of heat exchange tubes on a first side of the core define a first zone. A second group of the plurality of heat exchange tubes on a second side of the core define a second zone. An inlet tank is at the inlet end of the core opposite to both the first zone and the second zone. An inlet port of the inlet tank is opposite to an interface between the first zone and the second zone of the core. A first outlet tank is at the outlet end of the core opposite to the first zone. A first outlet port of the first outlet tank is at an outer end of the first outlet tank. A second outlet tank is at the outlet end of the core opposite to the second zone. A second outlet port of the second outlet tank is at an outer end of the second outlet tank.

The present disclosure also provides for an HVAC system including a refrigerant heat exchanger with a core having a plurality of heat exchange tubes extending from an inlet end of the core to an outlet end of the core. A first group of the plurality of heat exchange tubes on a first side of the core define a first zone. A second group of the plurality of heat exchange tubes on a second side of the core define a second zone. A first inlet tank is at the inlet end of the core opposite to the first zone. A first inlet port of the first inlet tank is at an inner end of the first tank. A second inlet tank is at the inlet end of the core opposite to the second zone. A second inlet port of the second inlet tank is at an inner end of the second tank. A first outlet tank is at the outlet end of the core opposite to the first zone. A first outlet port of the first outlet tank is at an outer end of the first outlet tank. A second outlet tank is at the outlet end of the core opposite to the second zone. A second outlet port of the second outlet tank is at an outer end of the second outlet tank.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an exemplary HVAC system in accordance with the present disclosure;

FIG. 2 illustrates a refrigerant heat exchanger in accordance with the present disclosure for use with the HVAC system of FIG. 1; and

FIG. 3 illustrates another evaporator in accordance with the present disclosure for use with the HVAC system of FIG. 1.

Corresponding reference numerals indicate corresponding parts throughout the several views of the drawings.

### DETAILED DESCRIPTION

Example embodiments will now be described more fully with reference to the accompanying drawings.

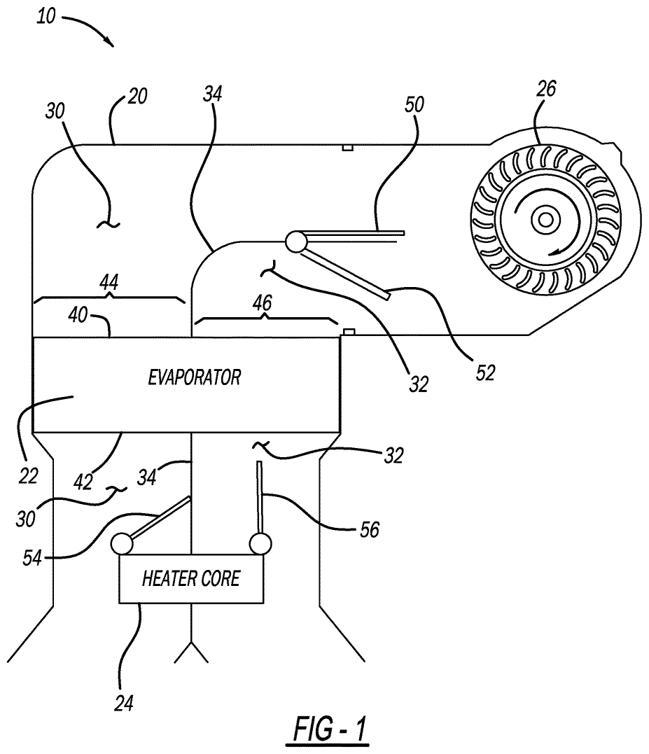

FIG. 1 illustrates an exemplary heating, ventilation, and air conditioning (HVAC) system 10 in accordance with the present disclosure. The HVAC system 10 may be configured for use with any suitable vehicle, such as any suitable passenger vehicle, utility vehicle, mass transit vehicle, construction vehicle/equipment, military vehicle/equipment, aircraft, watercraft, etc. The HVAC system 10 may be configured for use with any suitable non-vehicular application as well.

The HVAC system 10 includes a case 20 housing a refrigerant heat exchanger 22 and a heater core 24. A blower 26 may also be included within the case 20 as illustrated, or in a separate blower case. In the example illustrated, the case 20 defines a first airflow duct 30 and a second airflow duct 32. A divider 34 separates the first airflow duct 30 from the second airflow duct 32. The divider 34 is present at both an upstream end 40 and a downstream end 42 of the refrigerant heat exchanger 22. The first airflow duct 30 extends to and from a first zone 44 of the refrigerant heat exchanger 22. The second airflow duct 32 extends to and from a second zone 46 of the refrigerant heat exchanger 22. Airflow through the first airflow duct 30 is controlled by a first zone control door 50. Airflow through the second airflow duct 32 is controlled by a second zone control door 52.

The heater core 24 is arranged within the first airflow duct 30 and the second airflow duct 32 beyond the downstream end 42 of the refrigerant heat exchanger 22. First temperature control door 54 is movable to direct airflow within the first zone 44 through or around the heater core 24. A second temperature control door 56 is movable to direct airflow within the second zone 46 through or around the heater core 24.

The case 20 is configured to be connected to any suitable airflow ducts of a vehicle. For example, the first airflow duct 30 may be connected to airflow ducts at a driver side of a vehicle that the HVAC system 10 is installed in, and the second airflow duct 32 may be connected to airflow ducts at a passenger side of the vehicle. Thus, the amount of airflow to the driver side and the passenger side may be individually controlled by actuating the first and second zone control doors 50, 52. The temperature of airflow to the driver side and the passenger side may also be individually controlled by actuating the first and second temperature control doors 54, 56. For example, to maximize the temperature of airflow to the driver side, the first temperature control door 54 is positioned to direct all airflow from the first zone 44 through the heater core 24. To maximize cool airflow to the driver side, the first temperature control door 54 is rotated to restrict airflow through the heater core 24. The second temperature control door 56 may likewise be maneuvered to direct airflow through or around the heater core 24 to control the temperature of airflow to the passenger side.

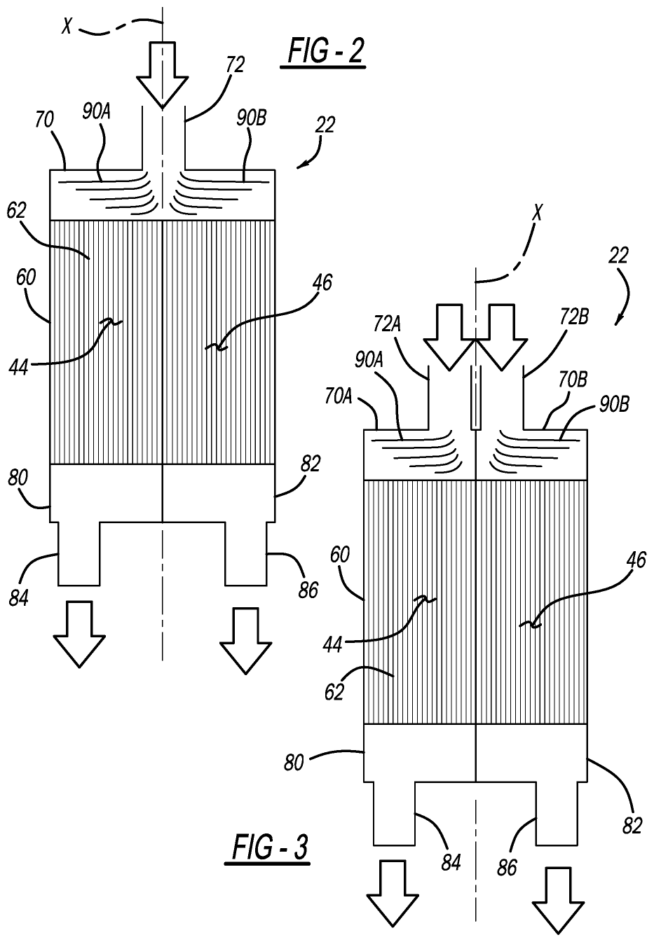

With continued reference to FIG. 1, and additional reference to FIGS. 2 and 3, the refrigerant heat exchanger 22 will now be described in additional detail. The refrigerant heat exchanger 22 includes a core 60 made of a plurality of heat exchange tubes 62. The plurality of heat exchange tubes 62 extend from an inlet end of the core 60 to an outlet end of the core 60. A first group of the plurality of heat exchange tubes 62 on a first side of the core 60 define the first zone 44 of the core 60. A second group of the plurality of heat exchange tubes 62 on a second side of the core 60 define the second zone 46.

With particular reference to FIG. 2, at the inlet end of the core 60 is an inlet tank 70, which includes an inlet port 72. The inlet port 72 is aligned with, or generally aligned with, an interface between the first zone 44 and the second zone 46 of the core 60. This interface may be at a center of the core 60, or offset from the center of the core 60. In the example illustrated in FIG. 2, the interface between the first zone 44 and the second zone 46 is at the center of the core 60, and a centerline X of the core 60 extends along the interface. The inlet port 72 is at the center of the inlet tank 70 and aligned along the centerline X. The inlet port 72 may alternatively be offset from the center of the inlet tank 70, such as when the interface between the first zone 44 and the second zone 46 is offset from the center of the tank.

At an outlet end of the core 60 is a first outlet tank 80 and a second outlet tank 82. The first outlet tank 80 and the second outlet tank 82 are not in direct fluid communication with each other. The first outlet tank 80 includes a first outlet port 84 at an outer end of the first outlet tank 80, which is distal to the centerline X. The first outlet port 84 is generally aligned with outermost ones of the plurality of heat exchange tubes 62 of the first zone 44. The second outlet tank 82 includes a second outlet port 86 at an outer end of the second outlet tank 82, which is distal to the centerline X. The second outlet port 86 is generally aligned with outermost ones of the plurality of heat exchange tubes 62 of the second zone 46.

Refrigerant enters the inlet tank 70 through the inlet port 72. To facilitate distribution of the refrigerant throughout the inlet tank 70 and across the plurality of heat exchange tubes 62, the inlet tank 70 may include first flow control members 90A and second flow control members 90B. The first and second flow control members 90A, 90B may be vanes, or any other suitable structure configured to evenly distribute refrigerant across the core 60.

From the inlet tank 70, refrigerant flows through the plurality of heat exchange tubes 62 to the first outlet tank 80 and the second outlet tank 82. Refrigerant exits the first outlet tank 80 through the first outlet port 84, and exits the second outlet tank 82 through the second outlet port 86. Again, the first outlet tank 80 and the second outlet tank 82 are not in direct fluid communication with one another.

The positions of the inlet port 72, the first outlet port 84, and the second outlet port 86 advantageously facilitate even distribution of refrigerant flow across the first zone 44 and the second zone 46. Having separate outlet tanks 80, 82, further facilitates even refrigerant distribution across the first zone 44 and the second zone 46. As a result, airflow across the first zone 44 and the second zone 46 is more evenly cooled by the refrigerant heat exchanger 22 as compared to previous evaporators.

FIG. 3 illustrates another configuration of the refrigerant heat exchanger 22 in accordance with the present disclosure. In the configuration of FIG. 3, the inlet tank 70 is configured as a first inlet tank 70A and a second inlet tank 70B. The first inlet tank 70A is opposite to the first zone 44, and the second inlet tank 70B is opposite to the second zone 46. The first inlet tank 70A includes a first inlet port 72A, and the second inlet tank 70B includes a second inlet port 72B. The first and second inlet ports 72A, 72B are arranged on opposite sides of the centerline X proximate to, or adjacent to, one another. Thus the first inlet port 72A is at an inner end of the first inlet tank 70A, and the second inlet port 72B is at an inner end of the second inlet tank 70B. The first inlet tank 70A and the second inlet tank 70B are not in direct fluid communication with one another.

To facilitate even distribution of refrigerant throughout the first inlet tank 70A across the heat exchange tubes 62 of the first zone 44, the first inlet tank 70A includes first flow control members 90A extending from the first inlet port 72A. Likewise, to facilitate even distribution of refrigerant throughout the second inlet tank 70B across the heat exchange tubes 62 of the second zone 46, the second inlet tank 70B includes second flow control members 90B extending from the second inlet port 72B.

The present disclosure thus advantageously provides for a refrigerant heat exchanger 22 that evenly distributes refrigerant across each one of the first zone 44 and the second zone 46. Airflow across the first zone 44 and the second zone 46 is therefore more evenly cooled by the refrigerant heat exchanger 22 as compared to previous evaporators. The refrigerant heat exchanger 22 thus provides generally even temperature distribution across each one of the first zone 44 and the second zone 46, and eliminates any need for separate evaporators for the driver side and the passenger side.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle heating, ventilation, and air conditioning (HVAC) system comprising:
a refrigerant heat exchanger including a core having a plurality of heat exchange tubes extending from an inlet end of the core to an outlet end of the core, a first group of the plurality of heat exchange tubes on a first side of the core define a first zone, and a second group of the plurality of heat exchange tubes on a second side of the core define a second zone;
an inlet tank at the inlet end of the core, an inlet port of the inlet tank is opposite to, or generally opposite to, an interface between the first zone and the second zone of the core;
a first outlet tank at the outlet end of the core opposite to the first zone, a first outlet port of the first outlet tank is at an outer end of the first outlet tank; and
a second outlet tank at the outlet end of the core opposite to the second zone, a second outlet port of the second outlet tank is at an outer end of the second outlet tank.

2. The HVAC system of claim 1, wherein the inlet port is directly opposite to the interface between the first zone and the second zone of the core.

3. The HVAC system of claim 1, wherein the inlet port is opposite to a center of the core.

4. The HVAC system of claim 1, wherein the inlet tank is opposite to both the first zone and the second zone of the core.

5. The HVAC system of claim 1, wherein the inlet tank includes a first tank portion opposite to the first zone and a second tank portion opposite to the second zone, the first tank portion and the second tank portion are not in direct fluid communication.

6. The HVAC system of claim 5, wherein the inlet port is a first inlet port of the first tank portion; and
wherein a second inlet port extends from the second tank portion.

7. The HVAC system of claim 6, wherein the first inlet port and the second inlet port are generally opposite to the interface between the first zone and the second zone of the core.

8. The HVAC system of claim 7, wherein the first inlet port and the second inlet port are on opposite sides of a center of the core.

9. The HVAC system of claim 1, wherein the first outlet tank and the second outlet tank are not in direct fluid communication.

10. The HVAC system of claim 1, wherein the inlet tank includes a plurality of flow control members configured to distribute refrigerant across the inlet end of the core.

11. The HVAC system of claim 10, wherein the flow control members include flow control vanes.

12. The HVAC system of claim 10, wherein the flow control members include first flow control members extending from the inlet port to a first area of the inlet tank opposite to the first zone; and
wherein the flow control members include second flow control members extending from the inlet port to a second area of the inlet tank opposite to the second zone.

13. The HVAC system of claim 8, wherein first flow control members extend within the first tank portion opposite to the first zone; and
wherein second flow control members extend within the second tank portion opposite to the second zone.

14. A vehicle heating, ventilation, and air conditioning (HVAC) system comprising:
a refrigerant heat exchanger including a core having a plurality of heat exchange tubes extending from an inlet end of the core to an outlet end of the core, a first group of the plurality of heat exchange tubes on a first side of the core define a first zone, and a second group of the plurality of heat exchange tubes on a second side of the core define a second zone;
an inlet tank at the inlet end of the core opposite to both the first zone and the second zone, an inlet port of the inlet tank is opposite to an interface between the first zone and the second zone of the core;
a first outlet tank at the outlet end of the core opposite to the first zone, a first outlet port of the first outlet tank is at an outer end of the first outlet tank; and
a second outlet tank at the outlet end of the core opposite to the second zone, a second outlet port of the second outlet tank is at an outer end of the second outlet tank.

15. The HVAC system of claim 14, wherein the inlet port is opposite to a center of the core.

16. The HVAC system of claim 14, further comprising:
first flow control members extending from the inlet port to a first area of the inlet tank opposite to the first zone; and
second flow control members extending from the inlet port to a second area of the inlet tank opposite to the second zone.

17. A vehicle heating, ventilation, and air conditioning (HVAC) system comprising:
a refrigerant heat exchanger including a core having a plurality of heat exchange tubes extending from an inlet end of the core to an outlet end of the core, a first group of the plurality of heat exchange tubes on a first side of the core define a first zone, and a second group of the plurality of heat exchange tubes on a second side of the core define a second zone;
a first inlet tank at the inlet end of the core opposite to the first zone, a first inlet port of the first inlet tank is at an inner end of the first inlet tank;
a second inlet tank at the inlet end of the core opposite to the second zone, a second inlet port of the second inlet tank is at an inner end of the second inlet tank;
a first outlet tank at the outlet end of the core opposite to the first zone, a first outlet port of the first outlet tank is at an outer end of the first outlet tank; and
a second outlet tank at the outlet end of the core opposite to the second zone, a second outlet port of the second outlet tank is at an outer end of the second outlet tank.

18. The HVAC system of claim 17, wherein the first inlet port and the second inlet port are on opposite sides of, and adjacent to, a centerline of the core extending along an interface between the first zone and the second zone of the core.

19. The HVAC system of claim 17, further comprising:
first flow control members extending within the first inlet tank opposite to the first zone; and
second flow control members extending within the second inlet tank opposite to the second zone.

20. The HVAC system of claim 17, wherein the first inlet tank and the second inlet tank are not in direct fluid communication; and
wherein the first outlet tank and the second outlet tank are not in direct fluid communication.
